(19) United States
(12) Patent Application Publication
(10) Pub. No.: US 2004/0124275 A1
(43) Pub. Date: Jul. 1, 2004

(54) Fuel injection system for internal combustion engines

(76) Inventors: Detlev Potz, Stuttgart (DE); Wendelin Potz, Stuttgart (DE); Maike Sander-Potz, Stuttgart (DE); Thomas Kuegler, Korntal-Muenchingen (DE); Predrag Nunic, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/468,451

(22) PCT Filed: Jul. 27, 2002
(86) PCT No.: PCT/DE02/02779

(30) Foreign Application Priority Data
Dec. 21, 2001 (DE) 101 63 654.7

(51) Int. Cl. F02M 59/00

(52) U.S. Cl. 239/533.2

(57) ABSTRACT

A fuel injection system having a housing (2), in which a pump piston (16) is disposed longitudinally movably, which piston positively displaces fuel from a pump work chamber (18) and delivers it to a pressure chamber (14). In a bore (42), an outer valve needle (44) is disposed longitudinally displaceably and cooperates with a valve seat, embodied on the end toward the combustion chamber of the bore (42), to control the opening of an outer row (70) of injection openings. The outer valve needle (44) experiences an opening force oriented away from the valve seat (48), as a result of the pressure in the pressure chamber (41), and a closing force, as a result of the force of an outer closing spring (52) disposed in an outer spring chamber (54). In the outer valve needle (44), an inner valve needle (46) is guided longitudinally displaceably, which likewise cooperates with the valve seat (48) to control an inner row (72) of injection openings. Not until the outer valve needle (44) lifts from the valve seat (48) does the inner valve needle (46) experience an opening force from the pressure in the pressure chamber (41) and a closing force from the force of an inner closing spring (62) disposed in an inner spring chamber (64); both in the outer spring chamber (54) and in the inner spring chamber (64), a low pressure always prevails (FIG. 1).

### PRIOR ART

The invention is based on a fuel injection system for internal combustion engines as generically defined by the preamble to claim 1. From German Patent Disclosure DE 197 52 834 A1, a fuel injection system is known in which a pump piston is disposed longitudinally movably in a piston bore. The pump piston is driven by the engine and in its pumping motion, it positively displaces fuel to a pump work chamber. In its stroke motion counter to the pumping motion, the pump piston aspirates fuel from an inflow chamber at slight pressure into the pump work chamber. In a bore embodied in the housing, a valve needle is disposed longitudinally displaceably; the valve needle cooperates with a valve seat, embodied on the end toward the combustion chamber of the bore, and thereby controls the opening of a row of injection openings embodied in the valve seat, because the valve needle, in its opening stroke motion, lifts from the valve seat, and thus fuel flows out of a pressure chamber, communicating with the pump work chamber, to the row of injection openings. In the process, because of the pressure in the pressure chamber, the valve needle experiences an opening force oriented away from the valve seat, and by the force of a prestressed closing spring in a spring chamber, it experiences a closing force oriented counter to the opening force. By way of the ratio of the opening force and the closing force, the valve needle can be controlled in its longitudinal motion, so that the row of injection openings can be opened and closed in a targeted way by way of the pressure in the pressure chamber.

The known fuel injection system has the disadvantage that in the injection of fuel into the combustion chamber of the engine, the same injection cross section is always opened. As a result, the injection rate is very high, so that injecting very small fuel quantities necessitates a very brief opening duration and hence very precise chronological control of the valve needle, which cannot always be accomplished with the requisite precision. As a result, ideal injection is not assured at every operating point of the engine.

### ADVANTAGES OF THE INVENTION

The fuel injection system of the invention having the definitive characteristics of claim 1 has the advantage over the prior art that, controlled by the pressure in the pressure chamber, either the entire injection cross section can be opened, or only a part of the injection cross section, by way of which the fuel is injected particularly at partial load of the engine. To that end, the valve needle is embodied as an outer valve needle and has a longitudinal bore, in which a further, inner valve needle is longitudinally displaceably guided. The inner valve needle likewise cooperates with the valve seat and in the process controls the opening of a further, inner row of injection openings. The inner valve needle is subjected to the closing force of an inner closing spring, which keeps it against the valve seat in the closing position. After the outer valve needle has lifted from the valve seat, the inner valve needle is likewise subjected to the fuel pressure of the pressure chamber and thereby experiences a hydraulic force, which as an opening force is oriented counter to the closing force. Via the pressure or the pressure course in the pressure chamber, it is thus possible to cause either only the outer valve needle, or in cascaded fashion first the outer valve needle and then the inner valve needle as well, to lift from the valve seat. Both in the outer spring chamber and in the inner spring chamber, a low pressure always prevails.

The subject of the invention can be further refined by advantageous features.

In one advantageous feature, both the outer spring chamber and the inner spring chamber each communicate, via a respective connecting bore, with the inflow chamber. Since only a slight fuel pressure always prevails in the inflow chamber, it is thus likewise assured that a high pressure cannot occur in either of the two spring chambers. Thus the closing force on the two valve needles remains constant, and no additional control of these closing forces is necessary. It is especially advantageous if a throttle is disposed in the connecting bores. As a result, pressure fluctuations that can occur in the inflow chamber are carried on to the spring chambers only with a certain damping, so that unwanted pressure conditions do not occur there.

In a further advantageous feature, the outer closing spring is braced on the outer valve needle via a spring plate, and the spring plate is guided with only slight lateral play in the outer spring chamber. The annular chamber remaining between the wall of the spring chamber and the spring plate communicates with a pressureless fuel return system and as a result is always pressureless. This feature makes it possible, by briefly raising the pressure in the inflow chamber and thus also in the outer spring chamber, to exert an additional closing force on the outer valve needle briefly, so that this needle closes in accelerated fashion at the end of injection. Because of the communication of the annular chamber with the pressureless fuel return system, the entire spring plate acts as a hydraulically effective piston in generating an additional closing force on the outer valve needle, and part of this is not compensated for by fuel pressure in the annular chamber.

In a similar way, an additional closing force can also be exerted on the inner valve needle. To that end, the inner valve needle is connected via a piston rod to a piston that is guided with only slight lateral play in the inner spring chamber. Once again, as a result of a briefly raised pressure in the inner spring chamber, an additional closing force on the inner valve needle is obtained. In this construction, it is especially advantageous if the annular chamber, which is formed between the piston rod and the central bore of the spring plate, is in communication with the annular chamber through a transverse bore embodied in the spring plate and as a result is likewise pressureless. As a result, fuel that reaches the space between the two valve needles is diverted into the fuel return system.

In another advantageous feature of the subject of the invention, the inner valve needle is embodied as shorter than the outer valve needle. As a result, the piston rod protrudes with part of its length into the longitudinal bore of the outer valve needle, where it rests on the end face of the inner valve needle. The inner valve needle can be guided closely in the longitudinal bore of the outer valve needle, while conversely the piston rod can have relatively great play in the longitudinal bore of the outer valve needle. Thus the inner valve needle, since the guided length is shorter, can be produced more simply and hence economically, and in addition, via the length of the piston rod, the force of the inner closing spring can be adjusted in a simple way, without requiring changes in the valve needle.

In another advantageous feature, a control valve is disposed in the communication of the inflow chamber with the pump work chamber and controls the communication, preferably electrically. If the control valve is open as long as a certain pressure is still present in the pump work chamber, then this pressure is depressurized into the inflow chamber, and given an existing communication with the spring chambers, into the spring chambers as well, causing a brief pressure increase that causes an additional force on the inner and outer valve needle as applicable. As a result, the closing motion of the valve needles can advantageously be accelerated.

Further advantages and advantageous features of the subject of the invention can be learned from the description and the drawing.

### DRAWING

In the drawing, one exemplary embodiment of the fuel injection system of the invention is shown. Shown are:

FIG. 1, a fuel injection system in longitudinal section in the installed position in the cylinder head of an internal combustion engine;

FIG. 2, an enlarged detail of the injection valve;

FIG. 3, an enlargement of FIG. 2 in the region of the valve seat;

FIG. 4, an enlargement of FIG. 2 in the region of the spring plate;

FIG. 5, an enlargement of FIG. 2 in the region of the inner spring chamber; and

FIG. 6, two graphs that show the course over time of the valve needle stroke and the injection rate during one injection cycle.

### DESCRIPTION OF THE EXEMPLARY EMBODIMENT

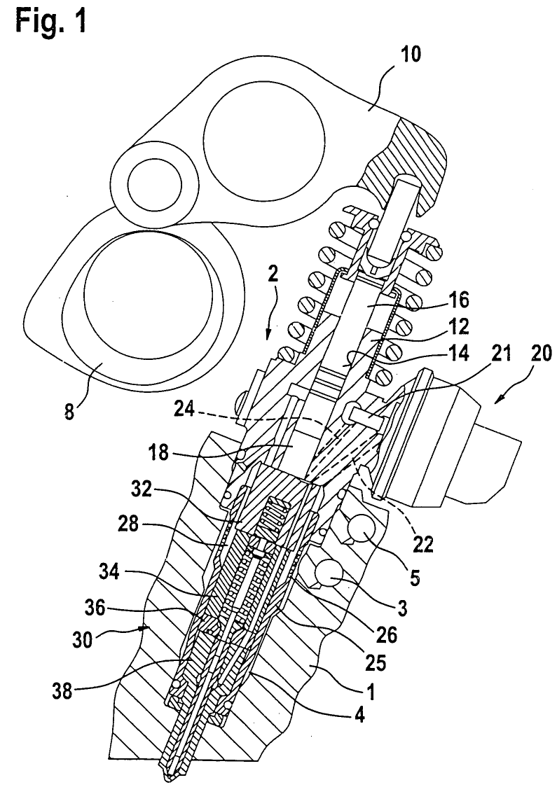

FIG. 1 shows a longitudinal section through a fuel injection system of the invention, in the installed position in an internal combustion engine, only part of which is shown. The engine has a cylinder head 1 with a receiving bore 4, in which a fuel injection system that has a housing 2 is disposed. The housing 2 includes an injection valve 30 and a pump body 12, in which a pump piston 16 is disposed longitudinally displaceably in a piston bore 14. The engine drives a cam 8, which via a tilt lever 10 exerts a longitudinal force on the pump piston 16, causing this piston to execute a longitudinal motion at the pace of the cam revolution in the piston bore 14. The pump body 12 communicates with the injection valve 30, which has a first valve body 32, a second valve body 34, an intermediate disk 36, and a nozzle body 38. It can also be provided that the first valve body 32 and the second valve body 34 are embodied as a single component. The injection valve 30 is held together and braced against the pump body 12 by a lock nut 25, and the lock nut 25 surrounds the nozzle body 38 partially and surrounds the intermediate disk 36, the first valve body 32, and the second valve body 34 entirely.

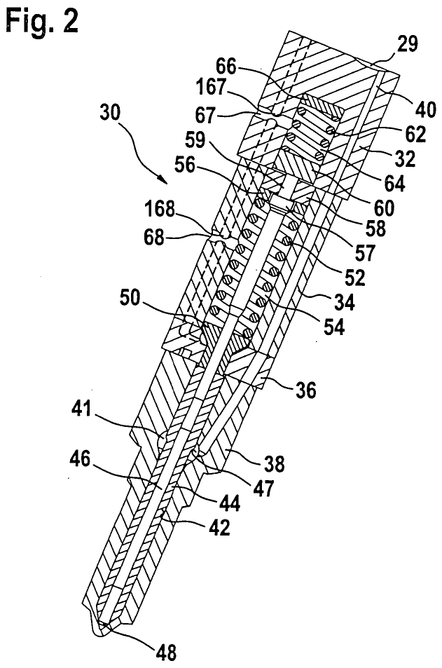

In the cylinder head 1, an inlet conduit 3 is embodied, which is shown in cross section in FIG. 1. Fuel at a certain low pressure, which as a rule does not exceed a few hundred kPa, is located in the inlet conduit 3. The inlet conduit 3 communicates with the receiving bore 4, so that the injection valve is surrounded by fuel. The lock nut 25 has a perforation 26, through which fuel from the inlet conduit 3 can flow into an inflow chamber 28 embodied between the first valve body 32 and the second valve body 34 on the one hand and the lock nut 25 on the other. From the inflow chamber 28, the fuel flows via an inlet conduit 22, embodied in the pump body 12, to a control valve 20, embodied here as an electrically operated magnet valve. The control valve 20 has a piston-shaped valve member 21, which is moved by an electromagnet and depending on its longitudinal position opens and closes the communication of the inlet conduit 22 with the connecting conduit 24. In the open position of the control valve 20, the inlet conduit 22 communicates with a connecting conduit 24 also embodied in the pump body 12, and this conduit discharges into the pump work chamber 18. If the pump piston 16 in its stroke motion moves away from the injection valve 30, fuel from the inflow chamber is carried into the pump work chamber 18, via the inlet conduit 22 and the connecting conduit 24. The pump work chamber 18 furthermore communicates with a high-pressure conduit 40 embodied in the first valve body 32, the second valve body 34, the intermediate disk 36, and the nozzle body 38; the communication comes about by means of a recess 29, embodied on the face end of the first valve body 32. FIG. 2 shows an enlargement of the injection valve 30 and the precise course of the high-pressure conduit 40.

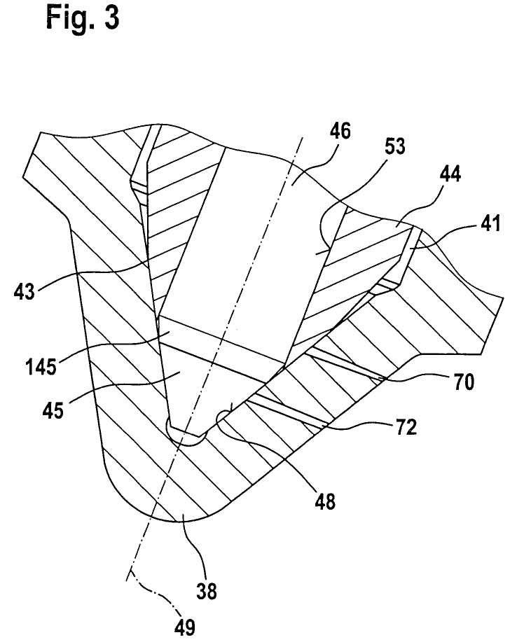

A bore 42 is embodied in the nozzle body 38 and has a longitudinal axis 49, and an outer valve needle 44 is longitudinally displaceable in this bore. The outer valve needle 44 is guided sealingly in a portion of the bore 42 remote from the combustion chamber, and toward the combustion chamber, it tapers, forming a pressure shoulder 47. An annular-conduitlike pressure chamber 41 is embodied between the outer valve needle 44 and the wall of the bore 42, and it widens radially at the level of the pressure shoulder 47; the high-pressure conduit 40 discharges into this radial enlargement of the pressure chamber 41. On the end toward the combustion chamber, the bore 42 is bounded by a conical valve seat 48, in which two rows 70, 72 of injection openings are embodied. FIG. 3 shows an enlargement of FIG. 2 in the region of the valve seat 38. The outer row 70 of injection openings is embodied upstream of the second row 72 of injection openings; each row 70, 72 of injection openings includes at least two injection openings, which are disposed at the same level in the bore 42 with respect to the longitudinal axis 49. The outer valve needle 44, on its end toward the combustion chamber, has a likewise conical valve sealing face 43, which in the closing position of the outer valve needle 44 comes to rest on the valve seat 48. Lifting the valve sealing face 43 from the valve seat 48 causes the pressure chamber 41 to communicate with the outer row 70 of injection openings, so that fuel from the pressure chamber 41 is injected into the combustion chamber of the engine through the outer row 70 of injection openings.

The outer valve needle 44 has a longitudinal bore 53, in which an inner valve needle 46 is longitudinally displaceably disposed. The inner valve needle 46 is embodied as shorter than the outer valve needle 44, so that upon contact with the valve seat 48, the inner valve needle 46 does not reach as far as the intermediate disk 36. The inner valve needle 46, on its end toward the combustion chamber, has a conical valve sealing face 45, which in the closing position comes to rest on the valve seat 48. Upon contact of the inner valve needle 46 with the valve seat 48, fuel can flow, as a result of the longitudinal motion of the outer valve needle 44, only to the outer row 70 of injection openings, but not to the inner row 72 of injection openings. Only when both the outer valve needle 44 and the inner valve needle 46 have lifted from the valve seat 48 does the fuel flow from the pressure chamber 41 to both rows 70, 72 of injection openings. The valve sealing face 45 of the inner valve needle 46 has as part of its surface a pressure face 145, which when the outer valve needle 44 is opened is acted upon by the fuel pressure of the pressure chamber 41, resulting in an opening force on the inner valve needle 46, which force is oriented away from the valve seat 48. In the same way, an exertion of pressure on the pressure shoulder 47 produces an opening force, oriented away from the valve seat 48, on the outer valve needle 44.

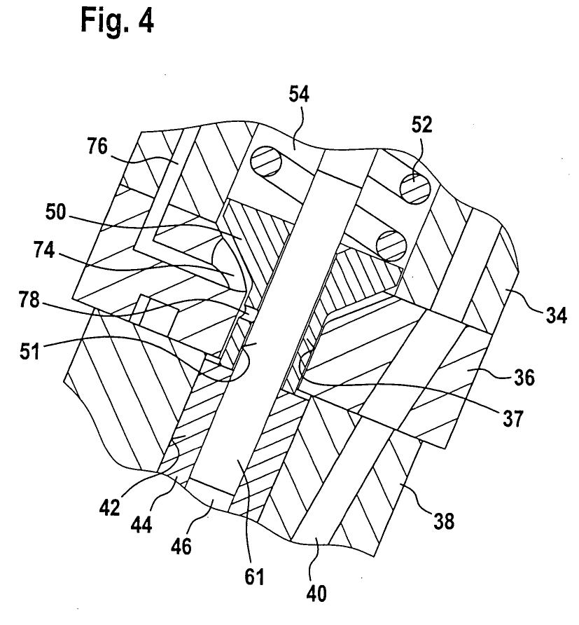

In the second valve body 34, an outer spring chamber 54 is formed, which communicates with the bore 42 via a central opening 37 embodied in the intermediate disk 36. FIG. 4 shows an enlargement of FIG. 2 in this region. A spring plate 50 is disposed in the central opening 37, and on the side toward the combustion chamber, an outer closing spring 52 disposed in the outer spring chamber 54 is braced on this spring plate. On the end remote from the combustion chamber, a stop disk 58 is disposed in the outer spring chamber 54, and the outer closing spring 52 is braced on this disk, with the interposition of a compensation disk 56 on the side remote from the combustion chamber. The outer closing spring 52 is embodied as a prestressed helical compression spring disposed in the outer spring chamber 54. Because of the prestressing of the outer closing spring 52, a closing force is exerted on the outer valve needle 44, pressing it in the direction of the valve seat 48.

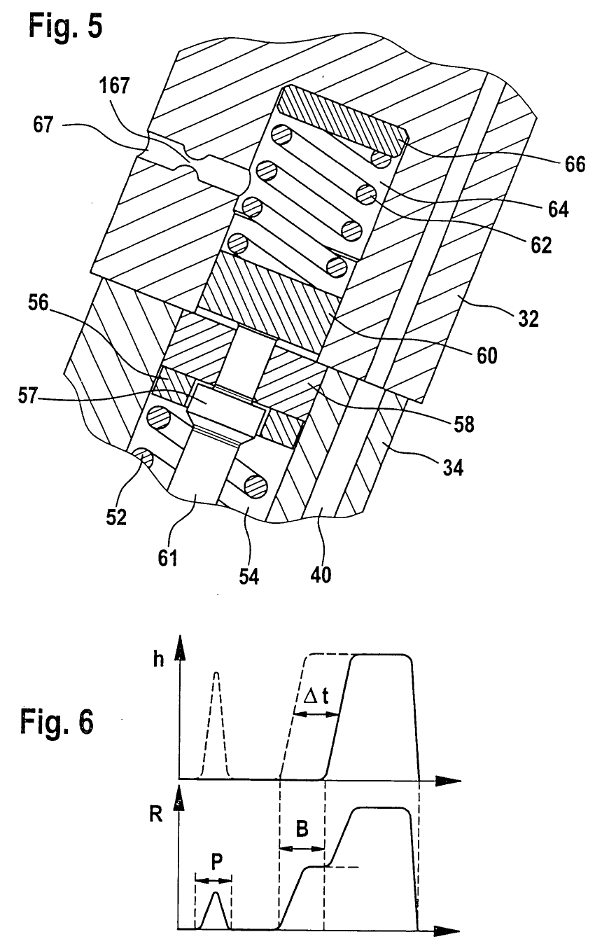

The spring plate 50 has a central bore 51, in which a piston rod 61 is disposed. The piston rod 61 rests with its end toward the combustion chamber on the inner valve needle 46, and with its end remote from the combustion chamber, it protrudes through the outer closing spring 52 into an inner spring chamber 64, which is embodied in the first valve body 32 remote from the combustion chamber relative to the outer spring chamber 54 and which is shown in more detail in FIG. 5. On its end remote from the combustion chamber, the piston rod 61 rests on a piston 60, which is guided in the inner spring chamber 64, and an inner closing spring 62 is disposed with compressive stress between this piston 60 and the bottom face, remote from the combustion chamber, of the inner spring chamber 64; an adjusting disk 66 is provided between the inner closing spring 62 and the bottom face of the inner spring chamber 64. The inner closing spring 62 is likewise disposed with compressive stress, so that via the piston rod 61, a force acting in the closing direction is exerted on the inner valve needle 46, pressing it in the direction of the valve seat 48. In the process, the piston rod 61 also protrudes through the stop disk 58 and the piston rod 61. The motion of the piston rod 61 and thus also of the inner valve needle 46 away from the combustion chamber is limited by a collar 57, embodied on the piston rod 61, which comes to rest on the stop disk 58 after the entire needle stroke has been executed.

The outer spring chamber 54 has a connecting bore 68 on its wall; this bore connects the outer spring chamber 54 with the inflow chamber 28. In the same way, the inner spring chamber 64 has a connecting bore 67 on its wall; it connects the inner spring chamber 64 with the inflow chamber 28. Since a low pressure always prevails in the inflow chamber 28, elevated pressure cannot build up either in the outer spring chamber 54 or in the inner spring chamber 64; in general, the pressure does not exceed a few hundred kPa.

The spring plate 50 is guided with only very slight play in the outer spring chamber 54. Conversely, in the intermediate disk 36, an annular chamber 74 is formed between the wall of the central opening 37 and the spring plate 50. To keep the annular chamber 74 pressureless at all times, a return conduit 76 is embodied in the intermediate disk 36, in the second valve body 34, and in the first valve body 32; it connects the annular chamber 74 with a return conduit 5, which is embodied in the cylinder head 1 and is part of a fuel return system and is always pressureless, so that the annular conduit 74 likewise always remains pressureless. In order for the fuel, which from the pressure chamber 41 gets into the space between the inner valve needle 46 and the outer valve needle 44, to be diverted into the return conduit 5, a transverse conduit 78 is embodied in the spring plate 50; it connects the central bore 51 with the annular chamber 74. Fuel that because of the high pressure in the pressure chamber 41 reaches the space between the outer valve needle 44 and the inner valve needle 46 flows, driven by the pressure difference between the outer spring chamber 54 and the pressure chamber 41, in the direction of the outer spring chamber 54 between the two valve needles 44, 46, and thus reaches the space between the piston rod 61 and the central bore 51 of the spring plate 50. From there, the fuel flows through the transverse bore 78 into the annular chamber 74 and from there into the return conduit 5. Thus a fuel inflow from the pressure chamber 41 into the outer spring chamber 54 is prevented.

The mode of operation of the fuel injection system is as follows:

By rotation of the cam 8 of the engine, the tilt lever 10 is actuated. The pump piston 16, which initially is in its terminal position remote from the combustion chamber, is now pressed by the tilt lever 10 in the direction of the combustion chamber, so that the fuel is positively displaced out of the pump work chamber 18. At the beginning of the injection cycle, the control valve 20 is opened, so that the fuel is pumped from the pump work chamber 18 into the inflow chamber 18, via the connecting conduit 24 and the inlet conduit 22. As a result, because of the large volume, only a slightly higher fuel pressure develops in the pump work chamber 18. If an injection is to be effected, the control valve 20 closes the communication of the valve body 24 with the inlet conduit 22. The pump piston 16 compresses the fuel in the pump work chamber 18, causing a higher fuel pressure to build up there. Via the recess 29 embodied in the face end of the first valve body 32, is guided into the high-pressure conduit 40, from which it reaches the pressure chamber 41 of the nozzle body 38. As a result of the increasing pressure in the pressure chamber 41, a hydraulic force is exerted on the pressure shoulder 47 of the outer valve needle 44 and on parts of its valve sealing face 43. As soon as the hydraulic force on the pressure shoulder 47 exceeds the closing force of the outer closing spring 53, the outer valve needle 44 moves away from the valve seat 48 and uncovers the outer row 70 of injection openings. The fuel under pressure in the pressure chamber 41 flows between the valve sealing face 43 and the valve seat 48 and is injected through the outer row 70 of injection openings into the combustion chamber of the engine. Since the outer row 70 of injection openings represents only part of the entire injection cross section, for instance from 30% to 50% of it, the injection also takes place at only part of the maximum possible injection rate. The inner valve needle 46 initially remains closed, or in other words in contact with the valve seat 48, since the pressure face 145 of the inner valve needle 46 is not acted upon by the fuel pressure of the pressure chamber 41 until after the outer valve needle 44 has lifted from the valve seat 48. If the control valve 20 remains open, the fuel pressure in the pressure chamber 41 continues to rise, until the hydraulic force on the pressure face 145 of the inner valve needle 46 exceeds the force of the inner closing spring 62. The ratio of the hydraulically effective surface area of the pressure face 145 to the force of the inner closing spring 62 is markedly less than with the outer valve needle 44, so that the inner valve needle 46 does not open until the pressure in the pressure chamber 41 is substantially higher than the opening pressure for the outer valve needle 44. As soon as the inner valve needle 46 has also lifted from the valve seat 48, fuel flows out of the pressure chamber 41 to the inner row 72 of injection openings, and from there it is injected into the combustion chamber of the engine. The injection valve 30 is now opened with the full injection cross section and injects the fuel at the maximum available injection pressure into the combustion chamber of the engine. If the injection of fuel is to be terminated, the control valve 20 opens the communication of the connecting conduit 24 with the inlet conduit 22. As a result, the pump work chamber 18 is reconnected with the inflow chamber 28, so that the pressure in the pump work chamber 18 drops very quickly. As a result, the pressure in the high-pressure 40 and thus also in the pressure chamber 41 also drops, so that the hydraulic force on the outer valve needle 44 and on the inner valve needle 46 drops rapidly. Since the force of the inner closing spring 62 and of the outer closing spring 52 is now once again greater than the hydraulic forces on the valve needles 44, 46, these valve needles slide back into their closing position, that is, into contact with the valve seat 48, and thus close the rows 70, 73 of injection openings. The pump piston 16, which meanwhile has reached its bottom dead center point, is now moved back again in the opposite direction, so that now fuel from the inflow chamber 28 flows to the pump work chamber 18 via the connecting conduit 24 and the inlet conduit 22, until the pump piston 16 has reached its top dead center position. From there, the injection cycle begins over again.

Upon opening of the control valve 20 to terminate the injection of fuel into the combustion chamber of the engine, the fuel in the pump work chamber 18 expands into the inflow chamber 28. The result in the inflow chamber 28 is a brief pressure increase, which is propagated via the connecting bore 67 and the connecting bore 68 into the inner spring chamber 64 and the outer spring chamber 54, respectively. Because of the brief pressure rise in the spring chambers 54, 64, a hydraulic force is exerted on the piston 60 or spring plate 50. This force acts in the same direction as the force of the closing springs 62, 52 and thus leads to an accelerated closure of the two valve needles 44, 46. It can also be provided that the piston is disposed with relatively great play in the inner spring chamber 64. In that case, the hydraulic force on the piston 60 acts in only attenuated form, but under some circumstances this may be sufficient.

A throttle 167, 168 is disposed in each of the connecting bores 67, 68; its throttling action assures that pressure fluctuations cannot occur in the spring chambers 54, 64. Because of the large volume of the inflow chamber 28 and its communication with the inlet conduit 3 in the cylinder head 1, the pressure surge in the inflow chamber 28 is very rapidly reversed, so that even the brief pressure rise in the spring chambers 54, 64 is of only short duration, and very soon a constant, low fuel pressure, corresponding to the pressure in the inlet conduit 3, is again established. To prevent the hydraulic force on the spring plate 50 from being partially compensated for again by a corresponding pressure rise in the annular chamber 74, the spring plate 50 is guided with only slight play in the outer spring chamber 54. By means of the return conduit 76, it is assured that the annular chamber 74 is pressureless, and thus the brief pressure rise in the outer spring chamber 54 can develop its full action on the spring plate 50.

Besides the injection through both rows 70, 72 of injection openings, it can also be provided that fuel be directed to only the outer row 70 of injection openings, for instance in order to inject a small fuel quantity in a pilot injection, prior to the main quantity of the fuel. To that end, once the outer valve needle 44 has lifted from the valve seat 48, the control valve 20 is closed again, even before the pressure rise in the pressure chamber 41 suffices to move the inner valve needle 46 out of its closing position as well. As a result of the ensuing pressure drop in the pressure chamber 41, the outer valve needle 44 slides back into its closing position on the valve seat 48 again, while the inner valve needle 46 remains in its closing position. Since the outer valve needle 44 is guided on the inner valve needle 46, the result is an exact guidance of the outer valve needle 44 in this preinjection, making for very uniform injection through all the injection openings of the outer row 70 of injection openings.

FIG. 6 shows the course of the needle stroke h and the injection rate R over time through one injection cycle. In the upper graph, the needle stroke h is plotted; the needle stroke of the outer valve needle 44 is shown as a dotted line, while the needle stroke of the inner valve needle 46 is shown as a solid line. One injection cycle is shown, subdivided into a pilot injection and a main injection. The first closure of the control valve 20 causes a needle stroke of the outer valve needle 44 and thus causes approximately half of the available injection cross section to open, namely the cross section of the outer row 70 of injection openings. The injection rate R plotted in the lower graph briefly rises, until the pilot injection, here marked P, is ended again by the opening of the control valve 20. After a certain time, as a result of a renewed closure of the control valve 20, the main injection occurs. Once again, the outer valve needle 44 opens first, so that its stroke h increases accordingly, leading to a so-called boot injection, marked B in the lower graph. The injection rate R thus rises, but only to approximately half of its maximum value. After a time Δt, which is dimensioned in accordance with the ratio between the opening pressures of the outer valve needle 44 and the inner valve needle 46, the inner valve needle 46 opens as well and travels up to its maximum stroke. As a result, the injection rate R increases up to its maximum value, and it remains at that value until the injection as a whole is terminated by the opening of the control valve 20. The stroke of both valve needles 44, 46 drops back to zero again and thus the injection rate R does likewise.

1. A fuel injection system for internal combustion engines, having a housing (2), in which a pump piston (16) is disposed longitudinally movably in a piston bore (14) and is driven by the engine, and in its pumping motion, the pump piston (16) positively displaces fuel from a pump work chamber (18) and delivers it to a pressure chamber (41), and having a bore (42), in which an outer valve needle (44) is disposed longitudinally displaceably, and the outer valve needle (44) cooperates with a valve seat (48), embodied on the end toward the combustion chamber of the bore (42), and thereby controls the opening of an outer row (70) of injection openings, in that the outer valve needle (44) in its opening stroke motion lifts from the valve seat (48) and thus fuel from the pressure chamber (41) flows to the outer row (70) of injection openings, and the outer valve needle (44) experiences an opening force, oriented away from the valve seat (48), as a result of the pressure in the pressure chamber (41) and a closing force, oriented counter to the opening force, as result of the force of a prestressed outer closing spring (52) that is disposed in an outer spring chamber (54), characterized in that a longitudinal bore (53) is embodied in the outer valve needle (44), in which bore an inner valve needle (46) is guided longitudinally displaceably, which likewise cooperates with the valve seat (48) and thus controls the communication of an inner row (72) of injection openings, embodied in the valve seat (48), with the pressure chamber (41), where the inner valve needle (46) does not experience an opening force until after the outer valve needle (44) lifts from the valve seat (48) as a result of the pressure in the pressure chamber (41); and that by the force of an inner closing spring (62), under compressive stress, disposed in an inner spring chamber (64), a closing force oriented counter to the opening force is exerted on the inner valve needle (46); and that in both the outer spring chamber (54) and the inner spring chamber (64), a low pressure always prevails.

2. The fuel injection system of claim 1, characterized in that the pump piston (16), in its stroke motion oriented counter to its pumping motion, aspirates fuel at slight pressure from an inflow chamber (28).

3. The fuel injection system of claim 2, characterized in that the outer spring chamber (54) and the inner spring chamber (64) each communicate with the inflow chamber (28) via a respective connecting bore (67; 68).

4. The fuel injection system of claim 3, characterized in that a throttle (167; 168) is disposed in at least one of the connecting bores (67; 68).

5. The fuel injection system of claim 1, characterized in that the outer closing spring (52) is braced on the outer valve needle (44) via a spring plate (50); and that the spring plate (50) is guided with only slight lateral play in the outer spring chamber (54) in a region remote from the outer valve needle (44); and that the remaining annular chamber (74) between the spring plate (50) and the wall of the outer spring chamber (54) communicates with a pressureless fuel return system.

6. The fuel injection system of claim 5, characterized in that the inner valve needle (64) is braced on the inner closing spring (62) via a piston rod (61), and the piston rod (61) protrudes through a central bore (51) in the spring plate (50), and with a transverse bore (78) in the spring plate (50), which connects the annular gap between the wall of the central bore (51) and the piston rod (61) to the annular chamber (74).

7. The fuel injection system of claim 1, characterized in that the opening pressure of the outer valve needle (41) is less than the opening pressure of the inner valve needle (44).

8. The fuel injection system of claim 1, characterized in that the length of the inner valve needle (46) is less than the length of the outer valve needle (44).

9. The fuel injection system of claim 8, characterized in that the inner valve needle (46) is braced on the inner closing spring (62) via a piston rod (61), and the piston rod (61) protrudes with part of its length into the longitudinal bore (53) of the outer valve needle (44) and rests there on the end face, remote from the valve seat (48), of the inner valve needle (46).

10. The fuel injection system of claim 9, characterized in that the piston rod (61) has a greater play in the longitudinal bore (53) of the outer valve needle (44) than does the inner valve needle (46).

11. The fuel injection system of claim 1, characterized in that the inner valve needle (46) is braced on the inner closing spring (62) via a piston rod (61) and a piston (60) guided laterally in the inner spring chamber (64).

12. The fuel injection system of claim 11, characterized in that the piston (60) is guided sealingly in the inner spring chamber (64).

13. The fuel injection system of claim 1, characterized in that a control valve (20) is disposed in the connection of the inflow chamber (28) with the pump work chamber (18).

14. The fuel injection system of claim 13, characterized in that the control valve (20) is an electrically controlled magnet valve.
